(19) United States
(12) Patent Application Publication
(10) Pub. No.: US 2005/0245267 A1
(43) Pub. Date: Nov. 3, 2005

(54) Methods of allocating a channel to baseband processing units in a communication system

(76) Inventor: Roland J. Guethaus, Schwaig (DE)

Correspondence Address: HARNESS, DICKEY & PIERCE, P.L.C., P.O. Box 8910, Reston, VA, 20195, US

(21) Appl. No.: 10/835,114

(22) Filed: Apr. 30, 2004

(51) Int. Cl. H04Q 7/20

(52) U.S. Cl. 455/450

(57) ABSTRACT

In a method of allocating a channel to a baseband processing unit (BBU) in a wireless communication system to establish a call, a BBU from one of first or second pools is selected to support a new channel for establishing a call. Alternatively, a channel may be allocated to a BBU in the first or second pools based on system demand. In another aspect, a pool of BBUs may be searched for allocating a channel to a BBU in the pool, in which the first BBU in the pool determined as having free and/or available capacity to support the channel is selected, or a BBU having the lowest available free capacity is selected. Further, a channel may be allocated to a BBU in the pool having received the most recent channel, or to a BBU having the greatest available capacity, if the BBU having received the most recent channel is full.

### BACKGROUND OF THE INVENTION

1. Field of the Invention

The present invention is related, in general, to allocation of a given channel to a given baseband processing units (BBU) in a wireless communication system so as to establish a call.

2. Description of the Related Art

Expanded efforts are underway to support the evolution of the Universal Mobile Telecommunications System (UMTS) standard, which describes a network infrastructure implementing a next generation Wideband Code Division Multiple Access (W-CDMA) air interface technology. A UMTS typically includes a radio access network, referred to as a UMTS terrestrial radio access network (UTRAN). The UTRAN may interface with a variety of separate core networks (CN). The core networks in turn may communicate with other external networks (ISDN/PSDN, etc.) to pass information to and from a plurality of wireless users, or user equipments (UEs), that are served by radio network controllers (RNCs) and base transceiver stations (BTSs, also referred to as NodeBs), within the UTRAN, for example.

Standards related to UMTS have introduced several technologies in an effort to ensure that any associated control and/or data information is carried in an efficient manner, in an effort to improve overall system capacity. One set of issues being addressed by the 3rd Generation Partnership Project (3GPP), a body which drafts technical specifications for the UMTS standard and other cellular technologies, includes considerations related to freeing up capacity to handle incoming voice or data calls at the network.

A UMTS base station (NodeB) may include a set of baseband processing units (BBUs). A BBU, in general, may be configured for encoding transmit data and decoding receive data in order to adapt the data to the characteristics of a physical radio channel. A BBU may be configured to process several transport/physical channels in parallel.

The BBUs may be configured to support different data rates for multiple physical channels in parallel. The physical channels may be used to carry transport channels carrying control information and data. For example, in the uplink, transport channels are intended to be used to carry control information from the user equipment (UE), such as requests to set-up a call, as part of a random-access transmission in the uplink from a UE to a NodeB. The transport channel may also be used to send small amounts of packet data from the UE to the network.

In general, if a UE makes a call to the network, the call needs a channel and the NodeB selects a BBU having available capacity so the new channel can be allocated to the selected BBU. The BBU may be able to support multiple physical channels, depending on the spreading factor (SF) group of the new channel. Thus, a BBU may be able to support 2, 4 or 8 channels, so long as the channels (groups of 2, 4 or 8 channels) have the same SF group, sometimes referred to as a ‘data rate group’.

If multiple physical channels with different data rates are allocated to one BBU, there may be a danger of fragmentation, i.e., the free and/or available capacity of the BBU may not necessarily be available in one contiguous block, and may be split up into several disconnected pieces. In order to avoid fragmentation, only physical channels of certain data rates (SF groups) are allocated to a given BBU. These physical channels have the same ‘footprint’ on the BBU, e.g., the physical channels allocated to the BBU in the uplink all use spreading factor codes having the same footprint or structure, full chip, ½ chip, ¼ chip, etc. Once a physical channel is allocated to a BBU, the BBU is set to the structure of that physical channel, and placed in a dedicated pool of BBUs. Under these conditions, a newly received channel (assuming the new channel belongs to the same data rate group handled by the BBU) should be able to use any free and/or available capacity on the BBU.

A set of data rates supported by a given BBU may be divided into subsets, depending on whether the subsets may be simultaneously combined in a given BBU. In other words, all data rates which occupy the same footprint may be allocated or arranged in the same data rate group. Empty BBUs (an empty BBU is a BBU having no channels allocated to it) may be used for any given data rate group. However, as soon as the first physical channel is allocated to the BBU, only channels from the same data rate group may be added to that BBU. Accordingly, conventional administration of BBUs in a NodeB only allocates channels of the same data rate group to a given BBU.

In a conventional BBU administration implementation within a 3G wireless communication system implementing W-CDMA technologies, all the available BBUs in a given NodeB are divided into pools for each data rate group. The number of BBUs in each pool is determined based on an amount of expected traffic for the corresponding data rate group. In other words, each BBU in a given NodeB may have a dedicated or assigned data rate group that is fixed and does not depend on the actual user demand on the system.

When a new channel is to be set up (i.e., a request to allocate a new channel is received by a UE desiring to establish a call), all BBUs in the pool dedicated to the data rate group of the new channel are individually searched to determine if any BBU has free capacity. The first BBU with sufficient capacity gets the new channel. If no BBUs have sufficient capacity, then the request from the UE is refused by the NodeB. Accordingly, since there is a fixed relation of BBUs to given data rate groups, new requests for a given data rate group may possibly be rejected (if all BBUs for this data rate group are full), while other BBUs, dedicated to other data rate groups yet having sufficient capacity to handle the request, are sitting idle.

### SUMMARY OF THE INVENTION

Exemplary embodiments of the present invention are directed, in general, to methods for allocating a channel to a baseband processing unit (BBU) in a wireless communication system in order to establish a call. In an exemplary method, a given BBU from one of a first pool and a second pool may be selected, so that a new channel for establishing a call may be allocated to the selected BBU. In an aspect of the exemplary embodiments, the channel may be allocated to a given BBU in one of the first and second pools based on demand on the system. In another aspect of the exemplary embodiments, a given pool of BBUs may be searched for allocating the channel to a given BBU in the pool based on one or more allocation strategies. The channel may be allocated to the first BBU in the pool that is determined as having free and/or available capacity to support the channel. Alternatively, the channel may be allocated to a BBU having the lowest available free capacity to support the channel. In a further exemplary embodiment, a channel may be allocated to a BBU in the pool having received the most recent channel, or to a BBU having the greatest available capacity, if the BBU having received the most recent channel is full.

### BRIEF DESCRIPTION OF THE DRAWINGS

Exemplary embodiments of the present invention will become more fully understood from the detailed description given herein below and the accompanying drawings, wherein like elements are represented by like reference numerals, which are given by way of illustration only and thus do not limit the exemplary embodiments of the present invention.

FIG. 1 illustrates a high-level diagram of the UMTS architecture, in accordance with an exemplary embodiment of the invention.

FIG. 2A is a flowchart describing a method of allocating a channel to a BBU based on a request to establish a call in a wireless communication system, in accordance with an exemplary embodiment of the present invention.

FIG. 2B is a flowchart illustrating a request to release a channel allocated to a BBU, in accordance with an exemplary embodiment of the present invention.

FIG. 3 is a diagram illustrating an arrangement between idle and dedicated pools in accordance with an exemplary embodiment of the present invention.

FIG. 4 is a diagram for illustrating allocation strategies in accordance with the exemplary embodiments of the present invention.

### DETAILED DESCRIPTION OF THE EXEMPLARY EMBODIMENTS

Although the following description of the present invention is based on the Universal Mobile Telecommunications System (UMTS) network infrastructure implementing a next generation Wideband Code Division Multiple Access (W-CDMA) air interface technology, it should be noted that the exemplary embodiments shown and described herein are meant to be illustrative only and not limiting in any way. As such, various modifications will be apparent to those skilled in the art. For example, it will be understood that the present invention finds application to any medium access control protocol with multiple modes in other spread spectrum systems such as CDMA2000 systems, other 3G systems and/or potentially developing fourth generation (4G) wireless communication systems.

Where used below, base transceiver station (BTS) and NodeB are synonymous and may describe equipment that provides data connectivity between a packet switched data network (PSDN) such as the Internet, and one or more mobile stations. Additionally where used below, the terms user, user equipment (UE), subscriber, mobile station and remote station are synonymous and describe a remote user of wireless resources in a wireless communication network.

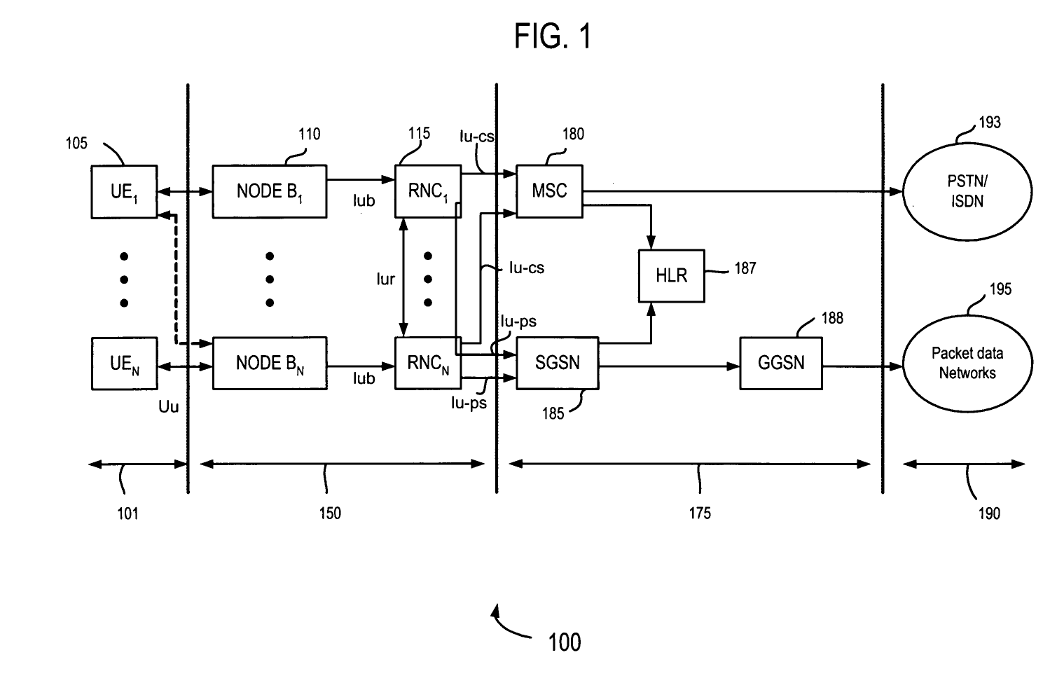

FIG. 1 illustrates a high-level diagram of an exemplary UMTS architecture, in accordance with an exemplary embodiment of the invention. Referring to FIG. 1, a UMTS architecture 100 comprises a radio access network part that may be referred to as a UMTS terrestrial radio access network (UTRAN) 150. The UTRAN 150 interfaces over a Uu air interface with a radio interface part 101; namely user equipments (UEs) such as mobile stations. The Uu air interface is the radio interface between the UTRAN 150 and one or more UEs 105. The UTRAN 150 also interfaces with one or more core networks (CNs) 175 (only one being shown in FIG. 1 for simplicity) via interfaces Iu-cs and Iu-ps, for example Iu-cs, short for Interface Unit (Circuit Switched) interface, is the interface in UMTS which links the RNC with a Mobile Switching Center (MSC). Iu-ps, short for Interface Unit (Packet Switched) interface, is the interface in UMTS which links the RNC with a Serving GPRS Support Node (SGSN). The Uu air interface enables interconnection of Node Bs with UEs, for example.

CN 175 may include mobile switching centers (MSCs) 180, SGSNs 185 and Gateway GPRS serving/support nodes (GGSNs) 188. SGSN 185 and GGSN 188 are gateways to external networks 190. In general in UMTS, SGSNs and GGSNs exchange packets with mobile stations over the UTRAN, and also exchange packets with other internet protocol (IP) networks, referred to herein as “packet data networks”. External networks 190 may include various circuit networks 193 such as a packet Switched Telephone Network (PSTN) or Integrated Service Digital Network (ISDN) and packet data networks 195. UTRAN 150 may also be linked to the CN 175 via back-haul facilities (not shown) such as T1/E1, STM-x, etc., for example.

The UTRAN 150 may include cell sites, called NodeBs 110, which may serve a group of UEs 105, generally using a Uu interface protocol. A NodeB 110 may contain radio transceivers that communicate using lub protocol with radio network controllers (RNCs) 115 in UTRAN 150. RNCs 115 within UTRAN 150 may communicate with each other using an lur protocol, for example. The Iur interface is a subset of the Iu interface that enables interconnection of RNCs with each other. Several Node Bs 110 may interface with a single RNC 115 where, in additional to call setup and control activity, tasks such as radio resource management and frame selection in soft handoff may be carried out. NodeBs 110 and RNCs 115 may be connected via links that use ATM-based packet transport, for example.

As to be discussed more fully below, the exemplary embodiments may be directed to methodologies for allocating a channel to a BBU in a wireless communication system in such a way that the administration and/or arrangement of BBUs at a NodeB to corresponding dedicated data rate groups is not preconfigured or fixed, but made according to a current demand of the system. The exemplary methodologies introduce dedicated pools of BBUs and an idle pool of empty BBUs (BBUs having no channel allocated thereto) and thus not set to a fixed structure of a channel (i.e., a given dedicated data rate group). BBUs thus may be arranged in either one or more dedicated pools or in an idle pool, but any empty (idle) BBU is placed in the idle pool. Thus, for each supported data rate group, a dedicated pool may be provided which includes all BBUs with at least one allocated channel of the corresponding data rate group. As previously discussed, as soon as a given BBU has been allocated a channel, it belongs to the data rate group of the channel it has accepted and is placed in a dedicated pool with other similarly situated BBUs, i.e., other BBU's configured to handle 2 channels, 4 channels, 8 channels or more depending on the spreading factor group (data rate group) of the channels. These pools may be empty, i.e. the pools may not contain any BBU.

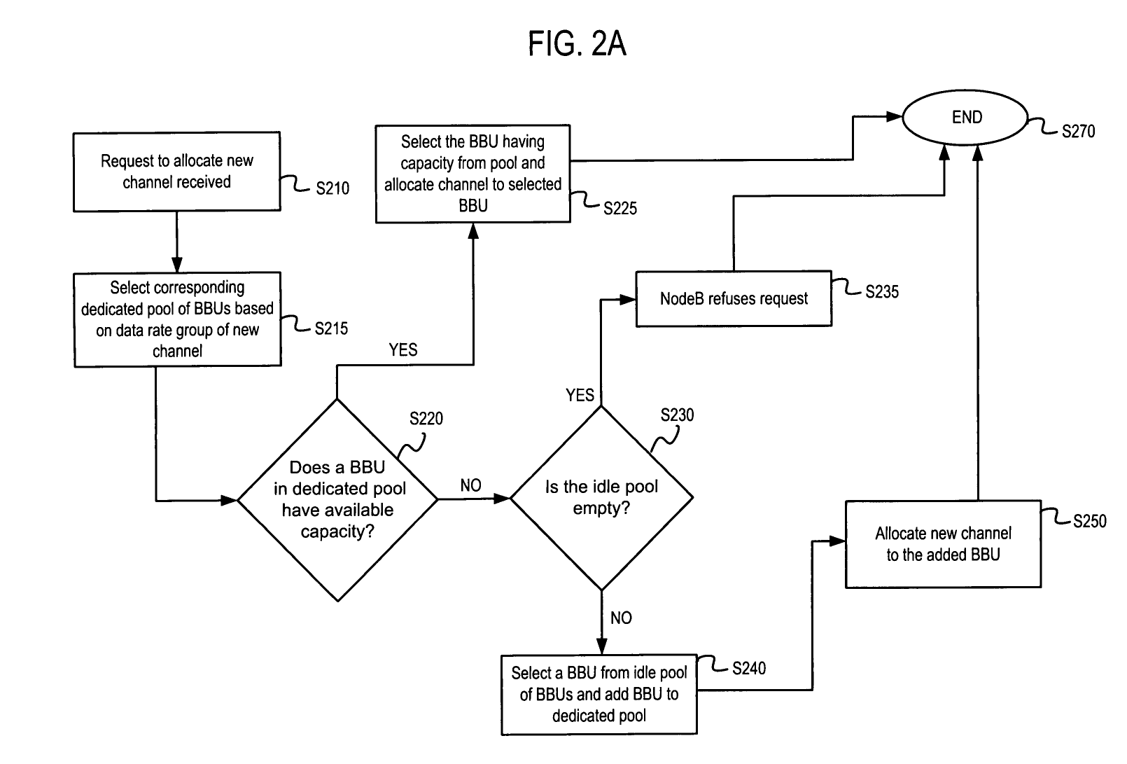

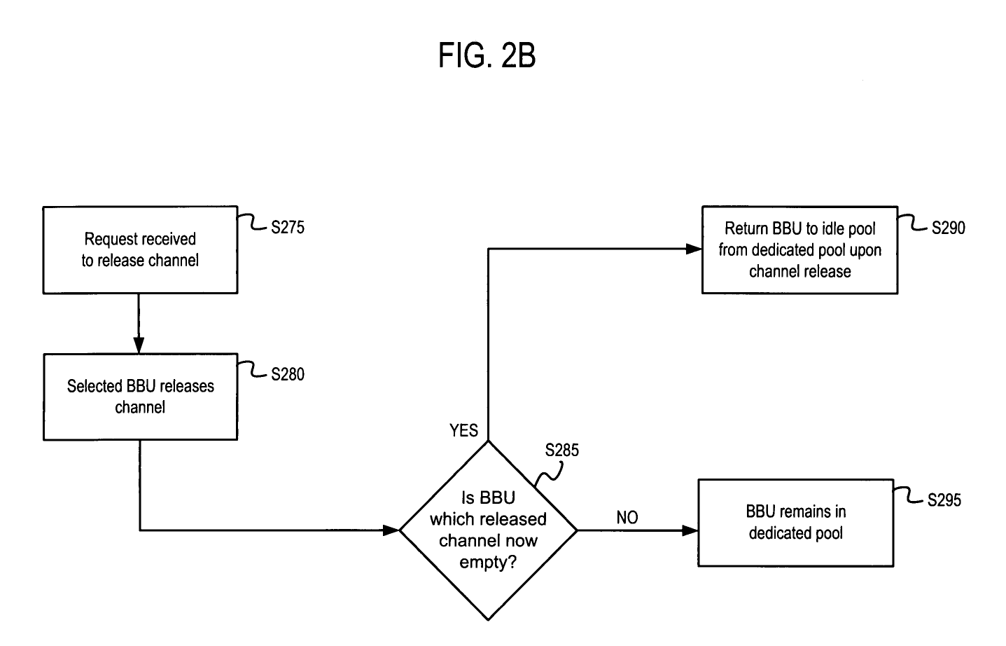

FIG. 2A is a flowchart describing a method of allocating a channel to a BBU based on a request to establish a call in a wireless communication system, in accordance with an exemplary embodiment of the present invention. Referring to FIG. 2A, if a new channel is to be set up (e.g., due to an request received (S210) from a UE), initially the corresponding dedicated pool is selected by the NodeB based on the data rate group of the new channel (S215) to determine which BBUs may have free capacity (S220). The request may be satisfied (output of S220 is ‘YES’) and a BBU having capacity is selected to be allocated the channel (S225).

If there is no BBU in the dedicated pool having sufficient capacity available for the new request (output of S220 is ‘NO’), then it is determined whether or not the idle pool is empty (S230). If so (output of S230 is ‘YES’), the NodeB refuses the request (S235) and the process ends (S270). Otherwise, a BBU maybe fetched from the idle pool and added to the dedicated pool (S240). The new channel may then be allocated (S250) to the added BBU and the process ends.

FIG. 2B is a flowchart illustrating a request to release a channel that has been allocated to a BBU, in accordance with an exemplary embodiment of the present invention. In the same layer that is used by the user to request a channel to establish a call, the UE may also send a request to the NodeB to release the channel, so as to terminate the call. This may be illustrated with reference to FIG. 2B.

Referring to FIG. 2B, to end the call the user sends a request (S275) to the NodeB to release a channel. The selected BBU releases (S280) the channel and it is then determined (S285) whether or not the BBU, upon channel release, is now empty. If so, (output of S285 is ‘YES’), the BBU is returned (S290) to the idle pool upon channel release. Otherwise, the BBU remains in the dedicated pool (shown as S295), as it has one or more channels allocated thereto.

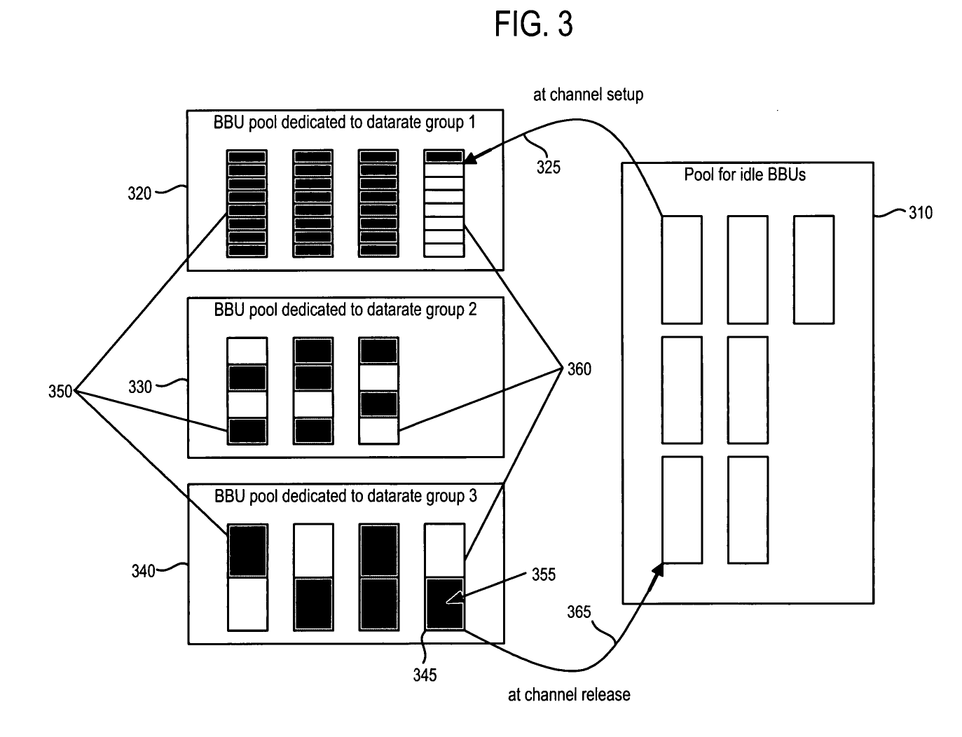

FIG. 3 is a diagram illustrating an arrangement between idle and dedicated pools in accordance with an exemplary embodiment of the present invention. Referring to FIG. 3, there is shown an idle pool 310 and three (3) dedicated pools 320, 330 and 340 of BBUs. The shaded portions 350 of BBUs in the dedicated pools 320-340 represent channels which are currently allocated to the BBUs. The opaque (clear) portions 360 of the BBUs illustrate free and/or available capacity adapted to be used for the allocation of new channels (i.e., new access requests to the system or network by users wanting to establish a voice and/or data call).

In FIG. 3, a channel set-up situation is shown for dedicated pool 320. For the new channel, a BBU may be fetched (shown at 325) from the idle pool 310, because all three BBUs in pool 320 are completely full. The selected BBU from idle pool 310 is removed from the idle pool and added to the dedicated pool 320.

Once a call is completed, the NodeB will receive a request to release the channel. As shown in FIG. 3, the channel is released from the last BBU 345, BBU 345 becomes free, and may be removed from the dedicated pool 340 and added (shown at 365) to idle pool 310, for example.

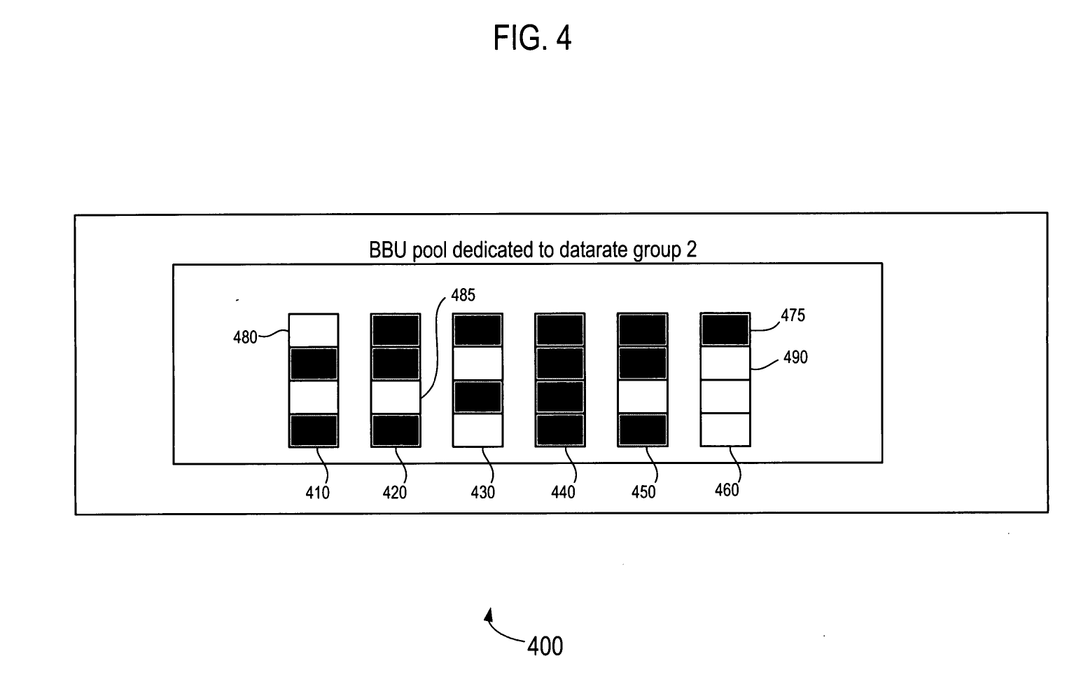

FIG. 4 is a diagram for illustrating allocation strategies in accordance with the exemplary embodiments of the present invention. When a new channel is set up, but not all BBUs in the corresponding dedicated pool are full, an allocation strategy may be employed which leads to a concentration of allocated channels on as few BBUs as possible. There may be a number of allocation strategies which may differ in complexity and performance.

Accordingly, it is desired that methodologies be provided which may help increase the probability that a given BBU becomes free (i.e., empty, has no channels allocated to it) which allows the BBU to be able to accept a channel at any data rate. FIG. 4 may thus be used to explain allocation strategies which may facilitate increasing the above probability. In FIG. 4, there is shown a dedicated pool 400 of BBUs 410-460, it being understood that a given dedicated pool could have fewer or greater than six BBUs.

Strategy 1

Referring to FIG. 4, one exemplary allocation strategy (Strategy 1) searches from one side of the pool to the other (in this example, left to right) in an effort to allocate the new channel to the first BBU with sufficient free capacity. This strategy is relatively simple in that it concentrates the channels on the leftmost BBUs (BBUs 410 to 450). If the demand can be fulfilled with BBUs 410-450 over a given allocation duration (allocation duration may represent the duration between the establishing of the call until the release of the channel, thus it may be a variable duration depending on the length of the voice and/or data call) which is greater than the allocation duration of the last channel 475 on BBU 460, BBU 460 becomes empty as the last channel 475 is released, and is returned to the idle pool 410. The new channel may thus be allocated to BBU 410, at slot 1 (shown at 480). Accordingly, Strategy 1 searches for and accepts the first BBU having free capacity to support a new channel.

Strategy 2

Another exemplary allocation strategy (Strategy 2) may search from left to right and allocate the new channel to the BBU having the lowest free capacity of all BBUs in the dedicated pool. In other words, Strategy 2 finds a BBU that has sufficient capacity remaining so that when a new channel is allocated to the BBU, that BBU becomes full. This strategy may more efficiently fill up a BBU, and hence may concentrate the channels on fewer numbers of full BBUs, before partially-filled BBUs are used. This may provide the partially-filled BBUs a greater opportunity to become empty (and hence be returned to the idle pool) than in the above-described Strategy 1. As shown in FIG. 4, in accordance with Strategy 2, the new channel may be allocated to BBU 420, slot 3 (shown at 485), which becomes full upon accepting the new channel.

Strategy 3

Another exemplary allocation strategy (Strategy 3) may search from left to right and allocate the new channel to a given BBU. However, in this exemplary strategy, the BBU which has most recently accepted a channel (last channel allocated to a BBU) is checked first to see if there is any remaining free capacity. If so, then the new channel is allocated to that BBU. If the BBU having been allocated the latest channel is full, then a BBU having the greatest or maximum available capacity may be selected. Channels with a longer allocation duration (older calls) have a higher probability of being released in the near future (sooner) than channels with a relatively short allocation duration (newer calls, which may be released later).

Thus, Strategy 3 may concentrate the new channels on the fewest number of BBUs, so as to provide other BBUs with older channels (in terms of allocation duration or period) a higher chance to empty sooner. Referring to FIG. 4, for Strategy 3, the new channel may be allocated to BBU 460, slot 2 (shown at 490), provided that the channel on BBU 460, slot 1 (shown at 475) was the last one allocated. For strategy 3, the identity of the BBU to which the last channel was allocated may be stored in a suitable memory. If this BBU is full, a search for a desired BBU may be performed.

Concentrating Channels to BBUs as a Channel is Released

As a channel is released, and in a case where after channel release there is only one channel left on its BBU, a check may be executed to determine whether or not another BBU in the same dedicated pool has sufficient capacity available for this last channel. If so, the last channel may be moved to the other BBU. The source BBU (now empty) may be returned to the idle pool 410. Alternatively, a check to determine whether a BBU may be freed by moving its channels to one or more BBUs in the same dedicated pool can be periodically performed as a housekeeping task, independently from channel release.

The exemplary methodologies described herein may offer several benefits. The method of allocating BBUs enables all BBUs in the idle pool to be accessible to all data rate groups. This may enable a given data rate group to have access to a greater number of BBUs than with the conventional fixed dedication arrangement. Additionally, the allocation of BBUs to a given data rate group may be based on the current demand in the data rate group. Thus, faster adaptation to varying demands in the data rate groups may be possible, and greater variety of demands in the different data rate groups may be supported on average, than for BBUs allocated based on a fixed dedication arrangement. Faster adaptation to demands may lead to a higher system throughput at the same quality of service (QoS). Further, more efficient utilization of BBUs may be possible, hence the number of BBUs that are needed may be reduced for the same amount of traffic, and/or the traffic may be increased for the same number of BBUs.

The allocation of BBUs to data rate groups may be performed dynamically (i.e., in essentially real time) and may reduce the time a BBU is unnecessarily maintained in a given dedicated pool, i.e., in a case where fewer numbers of BBUs are needed for the current demand.

The exemplary embodiments of the present invention being thus described, it will be obvious that the same may be varied in many ways. For example, the logical blocks in FIGS. 1-4 may be implemented in hardware and/or software. The hardware/software implementations may include a combination of processor(s) and article(s) of manufacture. The article(s) of manufacture may further include storage media, computer-readable media having code portions thereon that are read by a processor to perform the method, and executable computer program(s). The executable computer program(s) may include instructions to perform the described operations and the method. The computer executable(s) may also be provided as part of externally supplied propagated signals. Such variations are not to be regarded as a departure from the spirit and scope of the exemplary embodiments of the present invention, and all such modifications as would be obvious to one skilled in the art are intended to be included within the scope of the following claims.

1. A method of allocating a channel to a given baseband processing unit (BBU) for establishing a call in a wireless communication system, comprising:
determining whether a given BBU in a first pool of BBUs has available capacity to accept the channel; and
selecting a BBU from one of the first pool and a second pool based on the determination, so that the channel is allocated to the selected BBU.

2. The method of claim 1, wherein selecting includes allocating the channel to a BBU in the first pool, if a BBU in the first pool has available capacity.

3. The method of claim 1, wherein selecting includes allocating the channel to a BBU in the second pool, if no BBU in the first pool has available capacity to process the received request.

4. The method of claim 3, further comprising adding the selected BBU from the second pool to the first pool, prior to allocating the channel to the selected BBU.

5. The method of claim 4, further comprising returning the selected BBU to the second pool after the channel has been released, if the selected BBU is supporting no channels after channel release.

6. The method of claim 1, wherein the first pool is a dedicated pool of BBUs, each BBU in the first pool configured to support a given set of data rates.

7. The method of claim 1, wherein the second pool is an idle pool of BBUs, each BBU supporting no channels but having available capacity to support a channel for establishing a call that is received at any given data rate.

8. The method of claim 1, wherein a channel is allocated to a given BBU in one of the first and second pools based on user demand in the system.

9. The method of claim 1, wherein the channel for establishing the call is configured to support one of a voice connection and a data connection.

10. A method of allocating a channel to a given baseband processing unit (BBU) for establishing a call in a wireless communication system, in which a new received channel to be used for establishing a call between a user and the system is allocated to a given BBU from one of a first pool of BBUs and a second pool of BBUs based on system demand.

11. The method of claim 10, wherein the numbers of BBUs in one or more of the first pool and second pool changes based on changes in system demand.

12. In a wireless communication system, a base station including one of more BBUs to be allocated a channel for establishing a call between a user and the system in accordance with the method of claim 1.

13. In a wireless communication system, a base station including one of more BBUs to be allocated a channel for establishing a call between a user and the system in accordance with the method of claim 10.

14. A method of allocating a channel to a given baseband processing unit (BBU) for establishing a call in a wireless communication system, comprising:
searching a given pool of BBUs to selected a BBU for supporting the channel; and
allocating the channel to the first BBU in the pool determined as having available capacity to support the channel.

15. The method of claim 14, wherein
the pool has a first end and a second end, and
searching includes searching from the first end to the second end until the first BBU having available capacity is found.

16. A method of allocating a channel to a given baseband processing unit (BBU) for establishing a call in a wireless communication system, comprising:
searching a given pool of BBUs to select a BBU for supporting the channel; and
allocating the channel to the selected BBU, the selected BBU representing a BBU in the pool having the lowest available free capacity to support the channel.

17. The method of claim 16, wherein
the pool has a first end and a second end, and
searching includes searching from the first end to the second end until a BBU having the lowest available capacity is found, so that upon acceptance of the channel the BBU is full or substantially full.

18. A method of allocating a channel to a given baseband processing unit (BBU) for establishing a call in a wireless communication system, comprising:
searching a given pool of BBUs to select a BBU for supporting the channel; and
checking the BBU in the pool that has most recently been allocated a channel, and
allocating the channel to the BBU supporting the most recently allocated channel, if that BBU has available capacity, else
allocating the channel to the BBU in the pool having the greatest available capacity to support the channel.

19. The method of claim 18, wherein
the pool has a first end and a second end, and searching includes searching from the first end to the second end until a BBU having most recently been allocated a channel or a BBU having the greatest available capacity is found.

20. In a wireless communication system, a base station including one of more BBUs to be allocated a channel for establishing a call between a user and the system in accordance with the method of claim 14.

21. In a wireless communication system, a base station including one of more BBUs to be allocated a channel for establishing a call between a user and the system in accordance with the method of claim 16.

22. In a wireless communication system, a base station including one of more BBUs to be allocated a channel for establishing a call between a user and the system in accordance with the method of claim 18.
